(19) United States
(12) Patent Application Publication
(10) Pub. No.: US 2010/0230251 A1
(43) Pub. Date: Sep. 16, 2010

(54) Barrier Seal

(75) Inventors: Kjell Arne Gaarden, Heroya (NO); Kenneth Hovsto, Porsgrunn (NO)

Correspondence Address: CHRISTIAN D. ABEL, ONSAGERS AS, POSTBOKS 6963 ST. OLAVS PLASS, OSLO, N-0130, NO

(73) Assignee: AS TECHNO-TRACK, Porsgrunn (NO)

(21) Appl. No.: 12/305,653

(22) PCT Filed: Jun. 22, 2007
(86) PCT No.: PCT/NO07/00228

§ 371 Date: Mar. 10, 2009

(30) Foreign Application Priority Data
Jun. 22, 2006 (NO) 20062932

(51) Int. Cl. B65G 21/20; F16J 15/16; F16J 15/32; B65G 21/00

(52) U.S. Cl. 198/836.1

(57) ABSTRACT

The barrier seal (2) for use in a conveyor belt (4) installation comprises a wall section (20), a primary seal member (22) and a secondary seal member (24). The respective wall sections (20) are each clamped to the respective side walls (18) by a series of clamping brackets (19). The wall section (20), the primary seal member (22) and the secondary seal member (24) are conveniently moulded in a single unit from a EPDM rubber having a Shore hardness from (65) to (80).

The present invention relate to a barrier seal, a barrier seal assembly used in combination with a conveyor belt installation and its method of use. The invention may be used for controlling spillage of material from a belt conveyor particularly but not exclusively, in the lower region of a loading chute.

### BACKGROUND

In known belt conveyors there is a flexible continuous belt. The belt is supported by a series of roller assemblies that support the belt in a curved trough form. In such types of belt conveyors it is common to have a pair of skirt boards disposed each longitudinal side of the belt. These skirt boards help to retain the material transported on the belt. There is a particular need for extra sealing assemblies near the loading point of the material onto the belt. The material may be loaded onto the belt using a vertical chute. There is considerable increase in the load force of the material as it falls through the chute and impacts the belt. This may cause the belt to deflect and sag.

One know solution to this problem is shown in the prior art patent application number EP 0 462 847, in the name of Martin Engineering Company. This prior art document discloses a barrier seal assembly for a conveyor skirt board comprising a rigid primary seal spaced from a conveyor belt and a flexible secondary seal in contact with the belt. The two seals form an elongated tunnel formed with an elongated gap through which material may pass. In the prior art solution approx 5% of the material will move under the primary seal and into the tunnel to be carried away on the conveyor belt. The gap between the primary seal and the belt is partially there because of wear and tear. However, because there is a gap and because as much as 5% of the material enters the chamber, there must be an additional chamber outside this, which is provided by an extra labyrinth secondary seal at the outer end. The gap must also often be adjusted due to wear and this is time consuming and cumbersome. The extra labyrinth seal will prevent flying dust. This also results in a “wide” seal, i.e. it extends far out on the side of the chute because of the extra chamber and labyrinth seal. This is a problem as there is not always room for this type of “wide” seals.

A further problem is that the conveyor belt always sags (forms a belly shape) in the longitudinal direction between two rollers. This makes it difficult to align and adjust the known type of seal assembly as here will be leakage and gaps once the belt is loaded with material.

One of the objects of the present invention is to provide a more narrow seal such that the requirement of having two tunnel chambers may be avoided. Another object is to provide a good and tight seal with minimum maintenance and to provide a seal assembly that adjusts to the varying surface height of the belt.

### DISCLOSURE OF THE INVENTION

According to a first aspect of the present invention there is provided a barrier seal for use in a conveyor belt installation, the barrier seal comprising an elongated wall, an elongated primary seal and an elongated secondary seal, wherein the wall is adapted for suspended attachment above the load bearing surface of the conveyor belt and the primary seal extends from a lower portion of the wall towards the conveyor belt, the primary seal being adapted for contact with the conveyor belt and the secondary seal having a length substantially co-extensive with the primary seal and adapted for contact with the conveyor belt, the primary seal being adapted to provide a barrier for containing load material on an inboard side of the conveyor belt, and wherein the secondary seal in combination with the primary seal defines an elongate tunnel for confining load material that enters the tunnel.

The barrier seal is preferably used in combination with a skirt board in a conveyor belt installation. Alternatively, the barrier seal is adapted to form the skirt board element of the conveyor belt installation.

Preferably, the primary seal comprises a flexible sealing portion adapted for surface engagement against the conveyor belt. The flexible portion preferably allows the seal to move relative to the wall preferably in reaction to a relative movement of the belt.

The primary seal preferably forms an elongated cantilever pivotable about a pivot region extending between the wall and the primary seal. The flexible sealing portion and the pivotable feature will help the seal to stay in contact with the belt and helps the seal to follow the contours of the belt. The flexible portion and pivotable feature provide a dynamic seal capable of remaining in contact with the belt and following any deflection of the belt.

The pivot region is preferably formed by a region of reduced cross sectional thickness compared to the cross sectional thickness of the cantilever.

The cantilever, the wall and the pivot region are preferably form a single unit.

The cantilever preferably extends in direction towards the longitudinal central axis of the conveyor belt.

The primary seal is preferably formed from a material having a Shore hardness greater than or equal to 65.

The primary seal is preferably a material having a Shore hardness less than or equal to 80.

The primary seal is preferably a material having a Shore hardness in the range of 65 to 80.

Preferably, the secondary seal comprise a flexible sealing portion adapted for surface engagement against the conveyor belt.

The secondary seal preferably forms an elongated secondary cantilever pivotable about a secondary elongated pivot region extending between the wall and the secondary seal.

The secondary pivot region is preferably formed by a region of reduced cross sectional thickness compared to the cross sectional thickness of the secondary cantilever.

The secondary cantilever, the wall and the secondary pivot region preferably form a single unit.

The secondary cantilever preferably extends in direction away from the longitudinal central axis of the conveyor belt.

The secondary seal is preferably formed from a material having a Shore hardness greater than or equal to 65.

The secondary seal is preferably a material having a Shore hardness less than or equal to 80.

The secondary seal is preferably a material having a Shore hardness in the range of 65 to 80.

Preferably the primary seal has a Shore hardness that is greater than the Shore hardness of the belt of the conveyor.

Preferably the secondary seal has a Shore hardness that is greater than the Shore hardness of the belt of the conveyor.

Preferably, the wall of the seal has a Shore hardness is greater than the Shore hardness of the belt of the conveyor.

According to a second aspect of the present invention there is provided a barrier seal for use in a conveyor belt installation, the barrier seal comprising an elongated wall, an elongated primary seal and an elongated secondary seal, wherein the wall is adapted for suspended attachment above the load bearing surface of the conveyor belt and the primary seal extends from a lower portion of the wall towards the conveyor belt, the secondary seal in combination with the primary seal define an elongate tunnel for confining load material that passes between the primary seal and the conveyor belt, wherein at least one of the elongated primary seal and the elongated secondary seal of the barrier seal is a material that has a Shore hardness of greater than or equal to 65.

The barrier seal is preferably used in combination with a skirt board in a conveyor belt installation. Alternatively, the barrier seal is adapted to form the skirt board element of the conveyor belt installation.

Preferably the material has a Shore hardness less than or equal to 80.

The material preferably has a Shore hardness in the range of 65 to 80.

Preferably the material has a Shore hardness greater than the Shore hardness of the belt of the conveyor.

According to a third aspect of the present invention there is provided a method for controlling spillage of material in a conveyor system of the type having a conveyor belt, a skirt board disposed at a lower end of a loading chute comprising the steps of: suspending a flexible primary seal and a flexible secondary seal from the skirt board and engaging respective sealing portions against the material load bearing surface of the conveyor belt, thereby defining an elongate tunnel therebetween for retaining material which escapes between the primary seal and the conveyor belt and conveying the retained material through the tunnel.

The method preferably comprises a step of at least the primary seal having a self-adjusting characteristic such that, in use, the primary seal substantially remains in contact with the surface of the belt, in response to a movement of the conveyor belt.

According to a fourth aspect of the present invention there is provided a conveyor belt assembly comprising a seal according to the first aspect or the second aspect of the present invention.

According to a fifth aspect of the present invention there is provided a barrier seal for use in a conveyor belt installation, the barrier seal comprising an elongated wall and an elongated primary seal, wherein the wall is adapted for suspended attachment above the load bearing surface of the conveyor belt and a seal that extends from a lower portion of the wall towards the conveyor belt, the seal being adapted for contact with the conveyor belt and the primary seal being adapted to provide a barrier for containing load material on an inboard side of the conveyor belt.

The fifth aspect of the invention comprises a seal having just one seal element. In this aspect there is no secondary seal and therefore no tunnel. This aspect of the invention may be used for conveyors that do not have enough room at the edges of the belt for a wide seal including a tunnel element.

### BRIEF DESCRIPTION OF THE DRAWINGS

A specific embodiment of the invention will now be described by way of example only with reference to the accompanying drawings, in which:

FIG. 1 is a perspective view of a troughed conveyor belt and a loading chute;

FIG. 2 is a perspective view of one side of the conveyor belt shown in FIG. 1 and shows a more detailed view of a seal; and

FIG. 3 is a further perspective view of one side of the conveyor belt shown in FIG. 1.

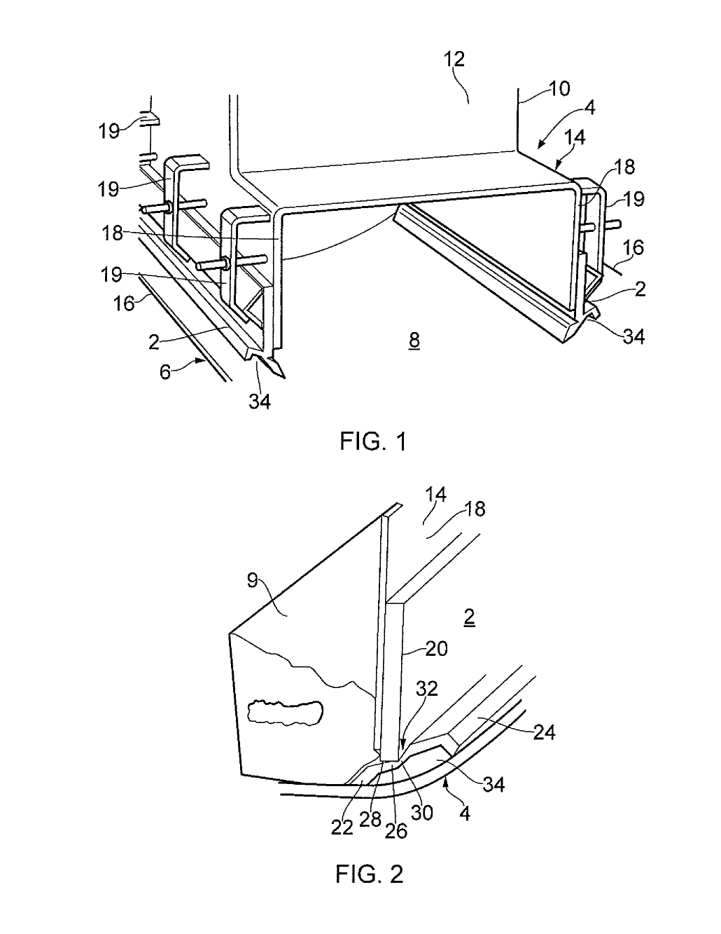

With reference to the FIGS. 1 to 3, there is shown a pair of barrier seals 2 of the present invention incorporated in a conveyor belt assembly 4. The conveyor belt installation 4 comprises a continuous conveyor belt 6 supported by a series of rollers (not shown), The belt 6 is held by the rollers in a trough-like configuration. Material 9 is loaded onto the upper surface 8 of the belt 6 via a loading chute 10. The material 9 is dropped through the chute 10 onto the surface 8 and the material 9 is then transported away from the chute 10 by the moving belt 6. The chute 10 comprises a vertical box section 12 and a horizontal tunnel section 14. As the material 9 is dropped onto the belt 6 there will be an impact force that tends to deflect the belt 6 downwards. The material will also tend to be pushed outwardly towards the respective longitudinal edges 16 of the belt 6. The side walls (skirt boards) 18 of the tunnel 14 will contain the majority of the material on the belt 6 but due to the downward deflection of the belt 6 there is a requirement for the respective additional seals 2.

Each seal 2 comprises a wall section 20, a primary seal member 22 and a secondary seal member 24. The respective wall sections 20 are each clamped to the respective side walls 18 (skirt boards) by a series of clamping brackets 19. The wall section 20, the primary seal member 22 and the secondary seal member 24 are conveniently moulded in a single unit from a material preferably having a Shore hardness in the range of 65 to 80, such as an EPDM rubber. It shall be appreciated that any other suitable materials, such as polyurethane, having the same or similar characteristics and properties may be used. In an alternative arrangement the seal 2 is formed from several parts, such as the three element parts, the wall 20, the primary seal 22 and the secondary seal 24, that are attached together to form the seal 2. Also, in an alterative arrangement the seal 2 is made from a material having a Shore hardness value in the range of 30 to 80. In prior art seals, the primary seal is made from a rigid material such as moulded nylon polymer having a Shore harness that is less than the Shore hardness of the belt.

The primary seal member 22 acts as a cantilever that is pivotable about an elongated pivot region 26. The pivot region 26 extends along the longitudinal length of the seal 2. The pivot region 26 is formed by an elongated notch cut-out 28 formed between the inner lowermost edge of the wall section 20 and the primary seal member 22. The distal end of the primary seal member 22 is in contact with the upper surface 8 of the belt 6. The primary seal member 22 extends from the lower edge of the wall section 20 in a direction downwards and towards the longitudinal centre of the belt 6.

The primary and secondary seals 22, 24 are preferably moulded in one unit. However, each of the individual elements of the respective seals may be formed separately and assembled together by a gluing or heat bonding operations or other suitable attachment method. The barrier seals 22, 24 are preferably used in combination with the side walls 18 of the conveyor belt installation. Alternatively, the barrier seals 22, 24 are adapted to form the side wall element of the tunnel 14.

The secondary seal member 42 also acts as a cantilever that is pivotable about an elongated pivot region 30. The second seal member 24 is substantially ‘L’ shaped. The pivot region 30 extends along the longitudinal length of the seal 2. The pivot region 30 is formed by an elongated notch cut-out 32 formed between the outer lowermost edge of the wall section 20 and the secondary seal member 24. The distal end of the secondary seal member 24 is in contact with the upper surface 8 of the belt 6. The secondary seal member 24 extends from the outer lower edge of the wall section 20 in a direction away from the longitudinal centre of the belt 6.

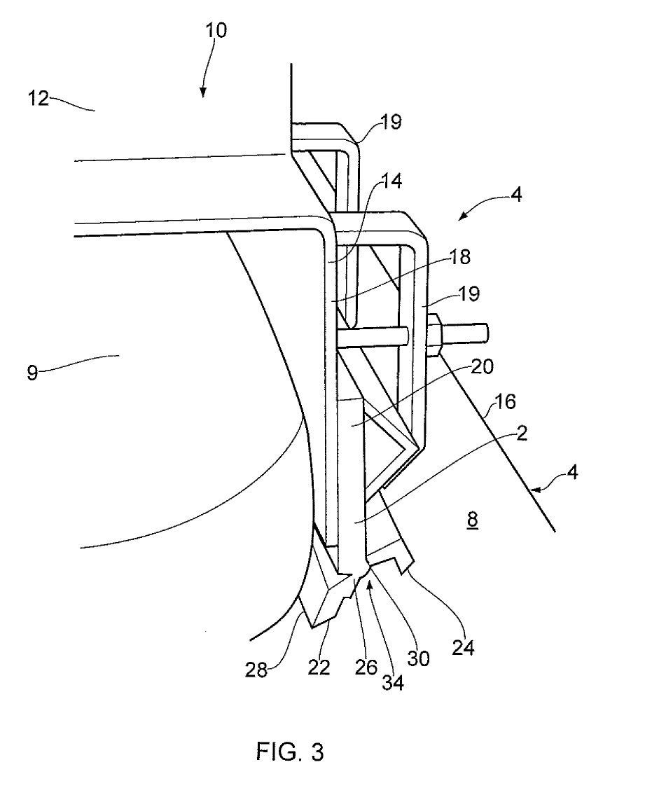

The primary seal member 22 and the secondary seal member 24 form an elongated tunnel void 34. In use the primary seal member 22 and the secondary seal member 24 are held substantially in contact with the surface 8 of the belt 6. When the material 9 is dropped onto the belt 6, the belt 6 may deflect and some material 9 may be forced between the primary seal member 22 and the upper surface 8. Such material will enter, and be contained within, the tunnel 34. The material within the tunnel 34 is subsequently transported by the moving belt 6 though the tunnel 34 and exits the tunnel 34. The material exiting the tunnel 34 will naturally fall back down the troughed sides of the belt 6 towards the centre of the belt 6. As shown in FIGS. 2 and 3, the material 9 within the tunnel section 14 of the chute 10 will come into contact with the primary seal member 22 and the weight of the material 9 will tend to push downwards onto the seal member 22. This force from the material 9 will help to keep the seal 22 in contact with the surface 8 of the belt 6 and therefore help to prevent any material 9 from being forced between the primary seal 22 and the belt 6 into the tunnel 34.

The fact that both the primary and the secondary seals 22, 24 are pivotable about respective pivot regions 26, 30 allows them to stay substantially in contact with the upper surface 8 of the belt 6 while the belt 6 is deflected up or down during use. Also, the primary sealing member 22 and the secondary sealing member 24 will have a degree of flexibility due to there shape and the material that they are made from; this will also help to keep the seals 22, 24 in contact with the surface of the belt 6 during the deflection of the belt 6.

It shall be appreciated that the seal in accordance with the present invention is not limited to being used in association with a loading chute but maybe used in any other location on a conveyor belt where the material transported by the belt may require some kind of barrier to help retain it on the belt.

The present invention provides a seal in contact with the belt on the inside (the material side) which is flexible and will always stay close to the belt. As shown in the Figures the distal end of the seal will be pushed down onto the belt by the material and will “flex” up and down together with the belt. Furthermore the seal shall have a Shore of approx 75+/−5. This is higher than the belt which is usually in the range of 55-65 Shore.

There is a problem if the seal is pushed all the way down to the belt because the seal edge in contact with the belt will wear. Thus it is not a good solution to have a rigid non flexible “slab” type seal which is pushed all the way down on setting up the sea as provided by the prior art installations. It was previously believed by the skilled person in the art that the seal should be softer (less Shore) than the belt as it was more expensive to change the belt than to change the seal. The present invention provides the opposite which is possible also because the new seal is flexible and adjusts itself to be close to the belt at all times. The result is that the seal is easily set-up because there is no further adjustment and no gap to which to pay attention. Furthermore the present invention solution requires less space than prior art (more narrow from less chambers). Maintenance is easy as there is little wear and no adjustment. The distal end or lip of the seals on the inside is itself adjusted as it is flexible and is pushed down by the material.

It is furthermore easy to convert from old seals to new seals as the old holders or clamps can be used with the new seal.

The flexible sealing portion and the pivotable feature will help the seal to stay in contact with the belt and helps the seal to follow the contours of the belt and these features provide a self-adjusting characteristic for the seals. The flexible portion and pivotable feature provide a self-adjusting dynamic seal capable of remaining in contact with the belt and following any deflection of the belt.

It shall be appreciate that the conveyor belt may be formed from a rubber material and this may be covered with a protective sheet. In some situations, such as in a chemical industry application, the conveyor belt may a steel material and this may be harder (Shore value) than the Shore value of the barrier seals.

In a further embodiment of the present invention the seal 2 for use in a conveyor belt installation comprises only the primary seal 22, wherein the wall is adapted for suspended attachment above the load bearing surface of the conveyor belt and the seal extends from a lower portion of the wall towards the conveyor belt, the seal being adapted for contact with the conveyor belt and the primary seal being adapted to provide a barrier for containing load material on an inboard side of the conveyor belt. In this aspect there is no secondary seal and therefore no tunnel. This aspect of the invention may be used for conveyors that do not have enough room at the edges of the belt for a wide seal including a tunnel element.

1-22. (canceled)

23. A barrier seal for use in a conveyor belt installation (4), the barrier seal (2) comprising an elongated wall (20), an elongated primary seal (22) and an elongated secondary seal (24), wherein the wall (20) is adapted for suspended attachment above the load bearing surface of the conveyor belt and the primary seal (22) extends from a lower portion of the wall towards the conveyor belt (6), the primary seal being adapted for contact with the conveyor belt (6) and the secondary seal (24) having a length substantially co-extensive with the primary seal (22) and adapted for contact with the conveyor belt (6), the primary seal (22) being adapted to provide a barrier for containing load material on an inboard side of the conveyor belt (6), and wherein the secondary seal (24) in combination with the primary seal (22) defines an elongate tunnel for confining load material that enters the tunnel, characterized in that the primary seal (22) forms an elongated cantilever pivotable about a pivot region (28) extending between the wall (20) and the primary seal (22), said pivot region (28) being formed by a region of reduced cross sectional thickness compared to the cross sectional thickness of the cantilever; and in that the secondary seal (24) forms an elongated secondary cantilever pivotable about a secondary elongated pivot region extending between the wall (20) and the secondary seal (24), said secondary pivot region being formed by a region of reduced cross sectional thickness compared to the cross sectional thickness of the secondary cantilever.

24. A barrier seal as claimed in claim 23, wherein the primary seal comprises a flexible sealing portion adapted for surface engagement against the conveyor belt.

25. A barrier seal as claimed in claim 23, wherein the cantilever, the wall and the pivot region form a single unit.

26. A barrier seal as claimed in claim 25, wherein the cantilever extends in direction towards the longitudinal central axis of the conveyor belt.

27. A barrier seal as claimed in claim 26, wherein the primary seal is a material having a Shore hardness greater than or equal to 65.

28. A barrier seal as claimed in claim 26, wherein the primary seal is a material having a Shore hardness less than or equal to 80.

29. A barrier seal as claimed in claim 26, wherein the primary seal is a material having a Shore hardness in the range of 65 to 80.

30. A barrier seal as claimed in claim 26, wherein the secondary seal comprise a flexible sealing portion adapted for surface engagement against the conveyor belt.

31. A barrier seal as claimed in claim 30, wherein the secondary cantilever, the wall and the secondary pivot region form a single unit.

32. A barrier seal as claimed in claim 31, wherein the secondary cantilever preferably extends in a direction away from the longitudinal central axis of the conveyor belt.

33. A barrier seal as claimed in claim 32, wherein the secondary seal is a material having a Shore hardness greater than or equal to 65.

34. A barrier seal as claimed in claim 32, wherein the secondary seal is a material having a Shore hardness less than or equal to 80.

35. A barrier seal as claimed in claim 32, wherein the secondary seal is a material having a Shore hardness in the range of 65 to 80.

36. A barrier seal as claimed in claim 31, wherein the seal has a Shore hardness value greater than the Shore harness valve of the belt of the conveyor.

37. A barrier seal as claimed in claim 23, wherein the cantilever, the wall and the pivot region form a single unit.

38. A barrier seal as claimed in claim 23, wherein the cantilever extends in direction towards the longitudinal central axis of the conveyor belt.

39. A barrier seal as claimed in claim 23, wherein the primary seal is a material having a Shore hardness greater than or equal to 65.

40. A barrier seal as claimed in claim 23, wherein the primary seal is a material having a Shore hardness less than or equal to 80.

41. A barrier seal as claimed in claim 23, wherein the primary seal is a material having a Shore hardness in the range of 65 to 80.

42. A barrier seal as claimed in claim 23, wherein the secondary seal comprise a flexible sealing portion adapted for surface engagement against the conveyor belt.

43. A barrier seal as claimed in claim 23, wherein the secondary cantilever, the wall and the secondary pivot region form a single unit.

44. A barrier seal as claimed in claim 23, wherein the secondary cantilever preferably extends in a direction away from the longitudinal central axis of the conveyor belt.

45. A barrier seal as claimed in claim 23, wherein the secondary seal is a material having a Shore hardness greater than or equal to 65.

46. A barrier seal as claimed in claim 23, wherein the secondary seal is a material having a Shore hardness less than or equal to 80.

47. A barrier seal as claimed in claim 23, wherein the secondary seal is a material having a Shore hardness in the range of 65 to 80.

48. A barrier seal as claimed in claim 23, wherein the seal has a Shore hardness value greater than the Shore harness valve of the belt of the conveyor.

49. A barrier seal as claimed in claim 31, wherein the secondary seal is a material having a Shore hardness greater than or equal to 65.

50. A barrier seal as claimed in claim 31, wherein the secondary seal is a material having a Shore hardness less than or equal to 80.

51. A barrier seal as claimed in claim 31, wherein the secondary seal is a material having a Shore hardness in the range of 65 to 80.

52. A barrier seal for use in a conveyor belt installation, the barrier seal comprising an elongated wall, an elongated primary seal and an elongated secondary seal, wherein the wall is adapted for suspended attachment above the load bearing surface of the conveyor belt and the primary seal extends from a lower portion of the wall towards the conveyor belt, the secondary seal in combination with the primary seal define an elongate tunnel for confining load material that passes between the primary seal and the conveyor belt, wherein at least one of the elongated primary seal and the elongated secondary seal of the barrier seal is a material that has a Shore hardness of greater than or equal to 65.

53. A barrier seal as claimed in claim 52, wherein the material has a Shore hardness less than or equal to 80.

54. A barrier seal as claimed in claim 52, wherein the material has a Shore hardness in the range of 65 to 80.

55. A barrier seal as claimed in claim 52, wherein the seal has a Shore hardness value greater than the Shore harness valve of the belt of the conveyor.

56. A barrier seal as claimed in claim 23 or claim 52, wherein the barrier seal comprises only the wall and the primary seal and there is no tunnel.

57. A conveyor belt assembly comprising a seal as claimed in any one of the claim 23 or 52.

58. A barrier seal as claimed in claim 53, wherein the material has a Shore hardness in the range of 65 to 80.

59. A barrier seal as claimed in claim 58, wherein the seal has a Shore hardness value greater than the Shore harness valve of the belt of the conveyor.

60. A barrier seal as claimed in claim 59, wherein the barrier seal comprises only the wall and the primary seal and there is no tunnel.

61. A conveyor belt assembly comprising a seal as claimed in claim 60.

62. A method for controlling spillage of material in a conveyor system of the type having a conveyor belt assembly as defined by claim 20, comprising a skirt board disposed at a lower end of a loading chute, said method comprising the steps of: suspending a flexible primary seal and a flexible secondary seal from the skirt board and engaging respective sealing portions against the material load bearing surface of the conveyor belt, thereby defining an elongate tunnel therebetween for retaining material which escapes between the primary seal and the conveyor belt and conveying the retained material through the tunnel.

63. A method as claimed in claim 62, wherein the method comprises the step of at least the primary seal having a self-adjusting characteristic such that, in use, the primary seal substantially remains in contact with the surface of the belt, in response to a movement of the conveyor belt.
